(19) United States
(12) Patent Application Publication
(10) Pub. No.: US 2026/0218563 A1
(43) Pub. Date: Jul. 30, 2026

(54) INSULATED GLAZING UNIT COMPRISING SOLID BODY SEALS AND METHODS FOR PRODUCING THE SAME

(71) Applicant: JELD-WEN, Inc., Charlotte, NC (US)

(72) Inventors: Yuxuan Gong, Boston, MA (US); Jason Kantola, Klamath Falls, OR (US)

(73) Assignee: JELD-WEN, Inc., Charlotte, NC (US)

(21) Appl. No.: 19/143,125

(22) PCT Filed: Dec. 22, 2023
(86) PCT No.: PCT/US2023/085712

§ 371 Date: Jun. 25, 2025

Related U.S. Application Data
(60) Provisional application No. 63/477,991, filed on Dec. 30, 2022.

(51) Int. Cl. E06B 3/673; E06B 3/66; E06B 3/663; E06B 3/677

(52) U.S. Cl. CPC E06B 3/67334; E06B 3/6612; E06B 3/66333; E06B 3/66357; E06B 3/6775

(57) ABSTRACT

Insulated glazing units for fenestration units and methods of producing the same are disclosed. The insulated glazing unit includes a first pane, a second pane, and solid spacers joining the first pane to the second pane along perimeters thereof. An intermediate space is defined between the first pane, the second pane, and the solid spacers. A first of the solid spacers includes a gas port with a first opening within the intermediate space, a second opening external to the intermediate space, and a passage therebetween, wherein the passage is sealed. The intermediate space is hermetically sealed by the first pane, the second pane, the solid spacers, and the gas port to maintain a gaseous insulative environment therein comprising a fill gas having a lower thermal conductivity than air.

### CROSS-REFERENCE TO RELATED APPLICATIONS

This application is a national phase of International Application No. PCT/US2023/085712, filed Dec. 22, 2023, which claims the benefit of U.S. Provisional Application No. 63/477,991, filed Dec. 30, 2022, the entire disclosures of which are incorporated by reference.

### TECHNICAL FIELD

The present disclosure generally relates to a fenestration unit and, more particularly, relates to an insulated glazing unit for a fenestration unit that includes at least two panes sealed along edges thereof with a solid body seal.

### BACKGROUND

A fenestration unit may include a frame (e.g., a rectangular frame) that supports one or more other members of the unit. For example, a panel of the fenestration unit (e.g., an active panel of a slider door or a window unit) may include a frame that supports a glazing unit, a door skin, or other component of the panel. Fenestration units having transparent panels may include windows, glass doors, sidelites, skylites, etc. Preferably, fenestration units are robust, weather resistant, and highly functional. Furthermore, these units are preferably manufacturable in an efficient and cost-effective manner. However, providing high-quality fenestration units is often associated with higher costs, longer manufacture time, higher part counts, and/or other challenges. Sealing these fenestration units with a sealant material may contribute substantially to these costs, inefficiencies, etc.

Thus, it is desirable to provide a high-quality fenestration unit that is highly weather resistant and robust. Furthermore, it is desirable to provide such units at reduced costs, using features that increase manufacturing efficiency. Other desirable features and characteristics of the present disclosure will become apparent from the subsequent detailed description and the appended claims, taken in conjunction with the accompanying drawings and this background discussion.

### BRIEF SUMMARY

In one embodiment, a method for producing an insulated glazing unit for a fenestration unit is disclosed. The method includes providing a first pane, locating and securing solid spacers on the first pane, wherein a first of the solid spacers includes a gas port, positioning a second pane on the solid spacers opposite the first pane, heating the solid spacers with a source of electromagnetic waves for a duration and at an intensity sufficient to weld the solid spacers to the first pane and the second pane to form a seal joining the first pane and the second pane, filling, through the gas port, an intermediate space defined between the first pane, the second pane, and the solid spacers with a fill gas having a lower thermal conductivity than air to produce a gaseous insulative environment in the intermediate space, and sealing the gas port and thereby hermetically sealing the intermediate space within the first pane, the second pane, the solid spacers, and the gas port to maintain the gaseous insulative environment therein.

In another embodiment, an insulated glazing unit for a fenestration unit is disclosed. The insulated glazing unit includes a first pane, a second pane, and solid spacers joining the first pane to the second pane along perimeters thereof. An intermediate space is defined between the first pane, the second pane, and the solid spacers. A first of the solid spacers includes a gas port with a first opening within the intermediate space, a second opening external to the intermediate space, and a passage therebetween, wherein the passage is sealed. The intermediate space is hermetically sealed by the first pane, the second pane, the solid spacers, and the gas port to maintain a gaseous insulative environment therein comprising a fill gas having a lower thermal conductivity than air.

### BRIEF DESCRIPTION OF THE DRAWINGS

The present disclosure will hereinafter be described in conjunction with the following drawing figures, wherein like numerals denote like elements, and wherein:

FIG. 1 is a flowchart illustrating a method for producing an insulated glazing unit according to example embodiments of the present disclosure;

FIGS. 2-12 include various views illustrating production stages of an insulated glazing unit according to example embodiments of the present disclosure;

FIG. 13 is a top view of an insulated glazing unit according to example embodiments of the present disclosure; and

FIG. 14 is a cross-sectional view of the insulated glazing unit of FIG. 13 in according to example embodiments of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

Broadly, example embodiments disclosed herein include insulated glazing units for fenestration units that include at least two panes sealed along edges thereof with a solid body seal and methods for producing the insulated glazing units. The insulated glazing units may include a fill gas disposed within an intermediate space defined between the two panes and the solid body seal to promote thermal insulation of the insulated glazing unit.

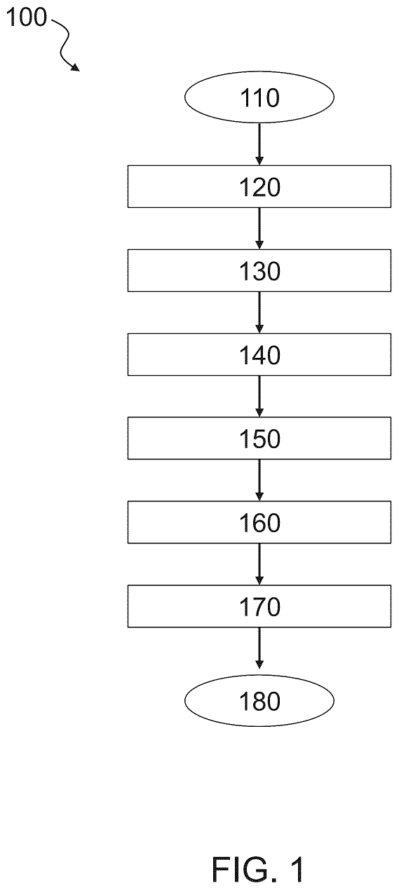

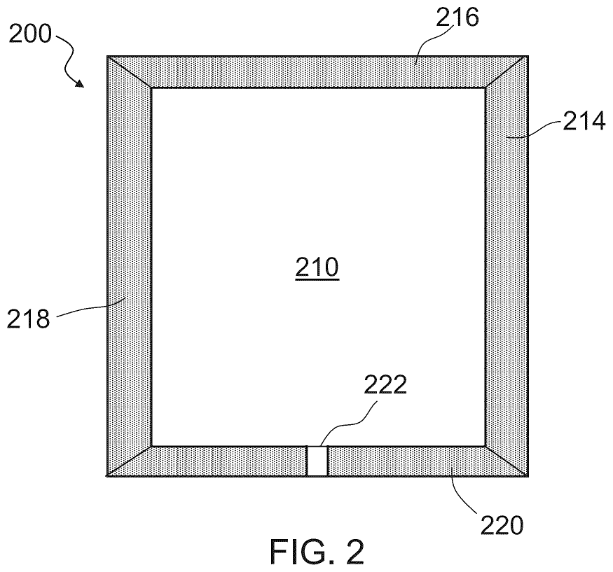

FIG. 1 presents steps of a nonlimiting method 100 for producing an insulated glazing unit. As can be appreciated in light of the disclosure, the order of operation within the method 100 is not limited to the sequential execution as illustrated in FIG. 1, but may be performed in one or more varying orders as applicable and in accordance with the present disclosure. For convenience, the method 100 will be described herein with reference to the embodiments of FIGS. 2-14; however, the method 100 is not limited to any particular size, structure, or application. The method 100 may start at 110.

At 120, the method 100 includes providing a first pane 210. At 130, the method 100 includes locating and securing one or more solid body spacers (also referred to as spacers) along an entirety of a perimeter of the first pane 210 (or around a portion thereof that is intended to be sealed). In the example of FIG. 2, four spacers 214, 216, 218, and 220 are arranged on the first pane 210 relative to each other to define a continuous rectangular shape. However, fewer or more spacers 214, 216, 218, and 220 may be used. At 140, the method 100 includes positioning a second pane 212 on the spacers 214, 216, 218, and 220 to define a spacer-pane assembly 200. The spacers 214, 216, 218, and 220 may be located between the first and second panes 210 and 212 such that the first and second panes 210 and 212 are spaced apart and define an intermediate (inter-pane) space 252 therebetween. At least one of the spacers 214, 216, 218, and 220 (e.g., 220) includes a gas port 222 to provide fluidic communication between the intermediate space 252 and an exterior atmosphere. Optionally, the spacers 214, 216, 218, and 220 may be physically or chemically bonded to the first pane 210 and/or the second pane 212. The spacers 214, 216, 218, and 220 are not limited to any particular size or shape and may have various thicknesses (perpendicular to the first pane 210 and the second pane 212) and various widths (parallel to the first pane 210 and the second pane 212).

The spacers 214, 216, 218, and 220 may include spacer-spacer contact surfaces therebetween having various profiles. For example, adjacent pairs of the spacers 214, 216, 218, and 220 may include substantially planar spacer-spacer contact surfaces therebetween that define about forty-five-degree angles to each other from the perspective of FIG. 2. However, the spacer-spacer contact surface profiles may be non-planar and/or may define other angles relative to each other.

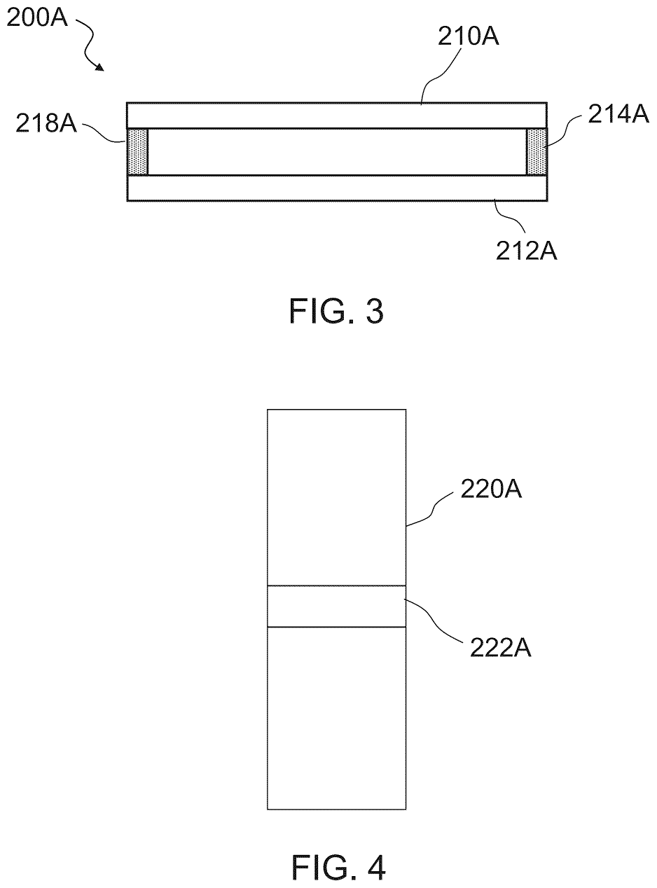

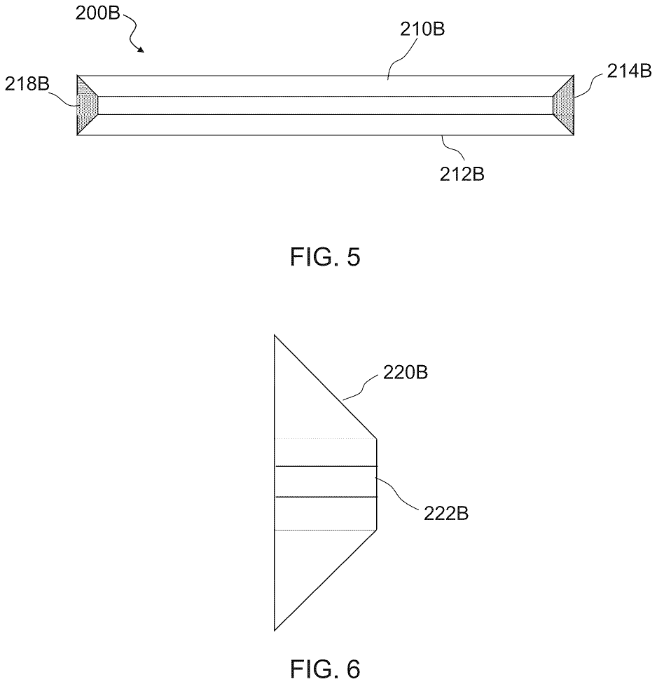

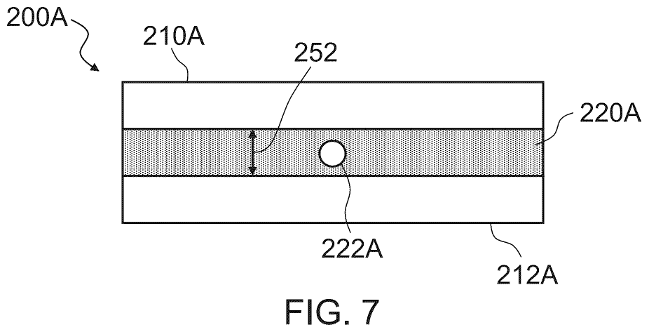

The spacers 214, 216, 218, and 220 may include spacer-pane contact surfaces between the spacers 214, 216, 218, and 220 and the first and second panes 210 and 212 having various profiles. FIG. 3 is a cross-sectional view of a first embodiment, referred to as the spacer-pane assembly 200A, in which the spacers 214A, 216A, 218A, and 220A include rectangular cross-sections and contact the first and second panes 210A and 212A with planar spacer-pane contact surfaces parallel to the faces of the first and second panes 210A and 212A. FIG. 5 is a cross-sectional view of a second embodiment, referred to as the spacer-pane assembly 200B, in which the spacers 214B, 216B, 218B, and 220B include isosceles trapezoidal cross-sections and contact the first and second panes 210B and 212B with planar spacer-pane contact surfaces at non-parallel, non-perpendicular angles (e.g., forty-five degrees) relative to the faces of the first and second panes 210B and 212B. FIGS. 4 and 6 are cross-sectional views of the spacers 220A and 220B of FIGS. 3 and 5, respectively, intersecting the gas ports 222A and 222B thereof. FIG. 7 shows an end or edge view of the spacer-pane assembly 200A as located between the first and second panes 210A and 212A.

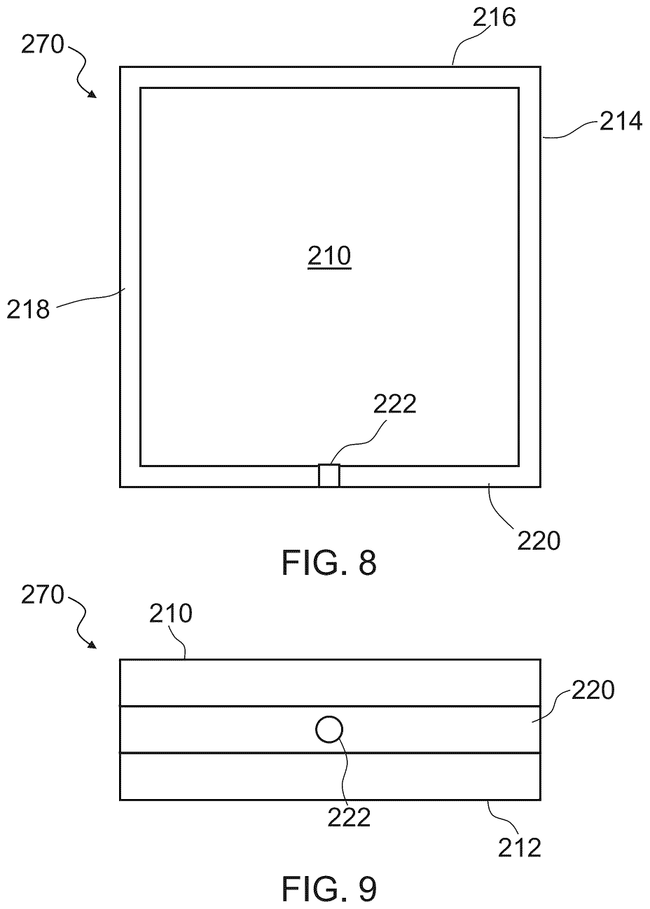

At 150, the method 100 includes heating the spacers 214, 216, 218, and 220 with a source of electromagnetic waves for a duration and at an intensity sufficient to weld the spacers 214, 216, 218, and 220 to the first pane 210 and the second pane 212 to form a seal joining the first pane 210 and the second pane 212 along perimeters thereof. Nonlimiting examples of electromagnetic waves include microwaves, continuous laser beams, or intermittent laser beams (e.g., femtosecond laser beams). FIGS. 8 and 9 represent the first and second panes 210 and 212 welded together by the spacers 214, 216, 218, and 220 subsequent to heating to define a bonded assembly 270.

At 160, the method 100 includes, filling, through the gas port 222, the intermediate space 252 defined between the first pane 210, the second pane 212, and the spacers 214, 216, 218, and 220 with a fill gas having a lower thermal conductivity than air to produce a gaseous insulative environment in the intermediate space 252. Exemplary gases include, but are not limited to, gaseous argon and gaseous krypton.

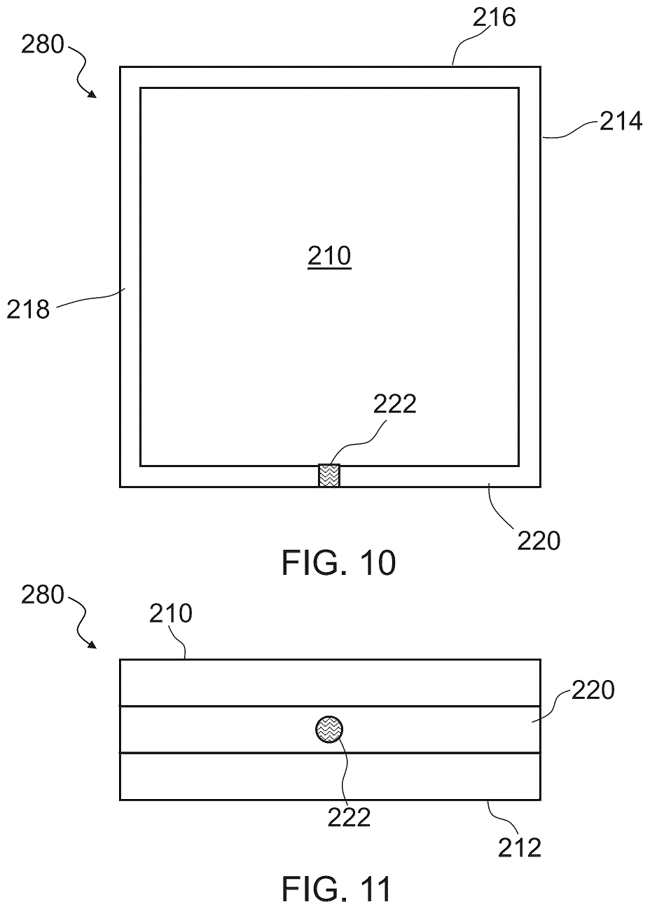

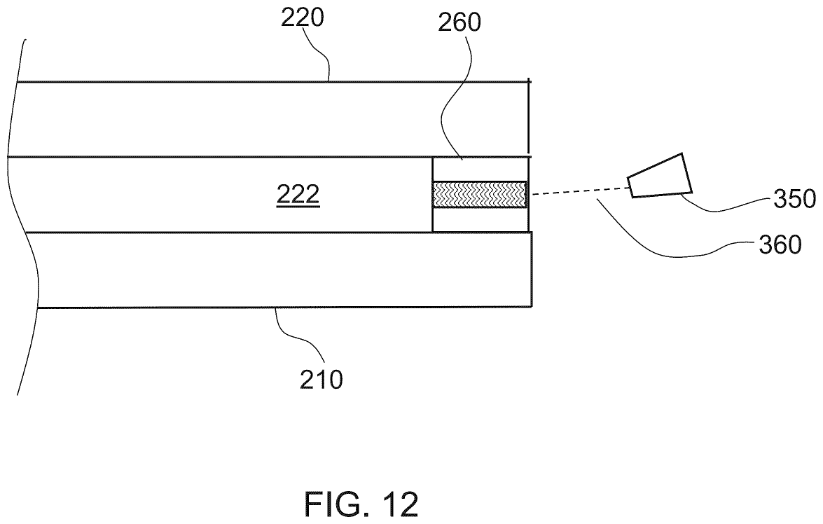

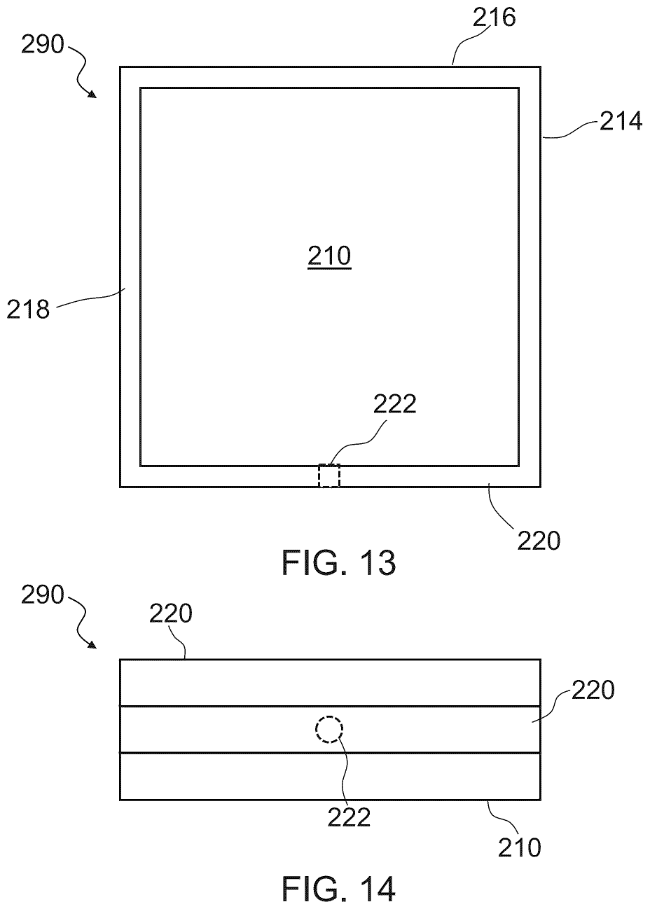

At 170, the method 100 includes sealing the gas port 222 and thereby hermetically sealing the intermediate space 252 within the first pane 210, the second pane 212, the spacers 214, 216, 218, and 220, and the gas port 222 to maintain the gaseous insulative environment therein. For example, FIGS. 10 and 11 represent the gas port 222 as filled with a glass paste or a glass tube to define a sealed assembly 280. FIG. 12 illustrates the glass paste or glass tube as being solidified and welded/bonded to interior walls of the gas port 222 with a laser beam 360 generated by a laser system 350. FIGS. 13 and 14 represent a final insulated glassing assembly 290 formed by the method 100. The method 100 may end at 180.

The first pane 210 and the second pane 212 may be formed of various materials, such as those commonly used in the art for glazing units. Nonlimiting examples of suitable materials include various glass materials (e.g., soda-lime glass) and certain transparent or semi-transparent polymeric materials. Processes for producing the first and second panes 210 and 212 are well known in the art and therefore will not be discussed in detail herein. A nonlimiting example includes the float glass process (i.e., the Pilkington process) and the down-drawing process (i.e., the Corning fusion process). The first pane 210 and the second pane 212 may be decorated using technologies such as and not limited to acid etch, screen printing of frit enamel or paint, and digital printing.

The spacers 214, 216, 218, and 220 may have compositions that are the same as the compositions of the first and second panes 210 and 212, or have compositions that are the different from the compositions of the first and second panes 210 and 212. The glass paste or glass tube used to fill the gas port 222 may have the same composition as the spacers 214, 216, 218, and 220. In some embodiments, the glass paste or glass tube may include a filler and/or organic compound to assist with applicability. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It is understood that various changes may be made in the function and arrangement of elements described in an exemplary embodiment without departing from the scope of the present disclosure as set forth in the appended claims.

1. A method comprising:
providing a first pane;
locating and securing solid spacers on the first pane, wherein a first of the solid spacers includes a gas port;
positioning a second pane on the solid spacers opposite the first pane;
heating the solid spacers with a source of electromagnetic waves for a duration and at an intensity sufficient to weld the solid spacers to the first pane and the second pane to form a seal joining the first pane and the second pane;
filling, through the gas port, an intermediate space defined between the first pane, the second pane, and the solid spacers with a fill gas having a lower thermal conductivity than air to produce a gaseous insulative environment in the intermediate space; and
sealing the gas port and thereby hermetically sealing the intermediate space within the first pane, the second pane, the solid spacers, and the gas port to maintain the gaseous insulative environment therein.

2. The method of claim 1, wherein the source of electromagnetic waves generates microwaves, continuous laser beams, or intermittent laser beams.

3. The method of claim 1, wherein the first pane and the second pane have rectangular shapes and locating the solid spacers on the first pane includes disposing the solid spacers along an entirety of a perimeter of the first pane.

4. The method of claim 3, wherein locating the solid spacers on the first pane includes locating spacer-spacer contact surfaces of adjacent pairs of the solid spacers in contact with each other to define forty-five-degree angles therebetween.

5. The method of claim 3, wherein the solid spacers have rectangular cross-sections and locating the solid spacers on the first pane include locating spacer-pane contact surfaces of the solid spacers in contact with the first pane to be parallel to faces of the first pane and the second pane.

6. The method of claim 3, wherein locating the solid spacers on the first pane include locating spacer-pane contact surfaces of the solid spacers in contact with the first pane to define forty-five-degree angles between the solid spacers and the first pane.

7. The method of claim 1, further comprising forming the solid spacers to have compositions that are the same as the compositions of the first pane and the second pane.

8. The method of claim 1, further comprising forming the solid spacers, the first pane, and the second pane of soda-lime glass.

9. The method of claim 1, further comprising forming the solid spacers to have compositions that are the different from the compositions of the first pane and the second pane.

10. The method of claim 1, wherein sealing the gas port includes disposing a fill material within the gas port that has a composition that is the same as compositions of the solid spacers and heating the fill material to solidify the fill material.

11. The method of claim 10, wherein heating the fill material is performed with the source of electromagnetic waves for a duration and at an intensity sufficient to solidify the fill material.

12. The method of claim 1, further comprising physically or chemically bonding the solid spacers to the first pane or the second pane prior to heating the solid spacers.

13. The method of claim 1, wherein sealing the gas port includes disposing a fill material within the gas port that has a composition that is a mixture of compositions of the solid spacers and a filler or organic compound and heating the fill material to solidify the fill material.

14. An insulated glazing unit comprising:
a first pane;
a second pane; and
solid spacers joining the first pane to the second pane along perimeters thereof;
wherein an intermediate space is defined between the first pane, the second pane, and the solid spacers;
wherein a first of the solid spacers includes a gas port with a first opening within the intermediate space, a second opening external to the intermediate space, and a passage therebetween, wherein the passage is sealed; and
wherein the intermediate space is hermetically sealed by the first pane, the second pane, the solid spacers, and the gas port to maintain a gaseous insulative environment therein comprising a fill gas having a lower thermal conductivity than air.

15. The insulated glazing unit of claim 14, wherein the first pane and the second pane have rectangular shapes and the solid spacers are disposed along an entirety of perimeters of the first pane and the second pane.

16. The insulated glazing unit of claim 14, wherein the solid spacers have compositions that are the same as the compositions of the first pane and the second pane.

17. The insulated glazing unit of claim 16, wherein the solid spacers, the first pane, and the second pane are formed of soda-lime glass.

18. The insulated glazing unit of claim 14, wherein the solid spacers have compositions that are the different from the compositions of the first pane and the second pane.

19. The insulated glazing unit of claim 14, wherein the passage is sealed with a fill material having a composition that is the same as compositions of the solid spacers.

20. The insulated glazing unit of claim 14, wherein the passage is sealed with a fill material having a composition that is a mixture of compositions of the solid spacers and a filler or organic compound.
